(19) United States
(12) Patent Application Publication
(10) Pub. No.: US 2002/0089534 A1
(43) Pub. Date: Jul. 11, 2002

(54) Interactive marketing guide

(76) Inventor: Rick L. Siekmann, Alpharetta, GA (US)

Correspondence Address: John L. DeAngelis, Jr., Esquire, Holland & Knight LLP, Suite 201, 1499 S. Harbor City Blvd., Melbourne, FL, 32901, US

(21) Appl. No.: 10/007,017

(22) Filed: Nov. 5, 2001

Related U.S. Application Data
(60) Provisional application No. 60/245,544, filed on Nov. 3, 2000.

(51) Int. Cl. G09G 5/00

(52) U.S. Cl. 345/738

(57) ABSTRACT

An interactive product or service marketing guide is provided on a portable storage device accessible and controllable by a microprocessor. The stored information includes businesses providing products consistent with the scope or focus of the product/service marketing guide. The business information is presented in the form of searchable business listing or directory. Advertising space is also available in the guide so that suppliers can provide additional information concerning their products as well as specific product information in the form of text, graphs, images, photographs, video clips, audio clips, printable information, etc. Information that is time sensitive is available to the user via an Internet link from the user's computer to the offering business website. The large storage capacity, searchable information sources and links to external Internet/world wide web sites make the marketing guide a significant improvement over prior art paper-based guides.

This patent application claims the benefit of the provisional patent application filed on Nov. 3, 2000, entitled eReloguide Media-rich Interactive Cross Platform Software, and which has been assigned application No. 60/245,544.

### FIELD OF THE INVENTION

This invention relates to the provision of product and service information to a user, and more specifically to the provision of such information by way of user-controlled portable data storage media storing information related to product or service offerings of various vendors, and further comprising Internet-linking capabilities to sites from which additional information can be retrieved to aid the user in the selection of the appropriate product or service.

### BACKGROUND OF THE INVENTION

Traditional printed documents, for example brochures, catalogs, flyers, etc., are the typical vehicle for providing information describing products and services offered by suppliers. These are passive forms of marketing because they provide no interaction with the user, cannot actively respond to user inquiries and generally require the user to execute several steps to contact the supplier for additional information not provided in the printed document. Typically, the consumer must place a telephone call to the supplier to request more information, as the directory information is limited by the prohibitive cost of printing detailed data and the difficulty of updating the printed material as new products and product version become available.

With the explosion of the Internet and the World Wide Web, many businesses are offering product and service information through this medium. But many potential buyers, especially senior citizens and residents of foreign countries lack Internet access. Further, many with Internet access suffer slow download times over low-bandwidth communications links, which protracts the information delivery time, especially data-intensive photographs and multimedia content. To compensate for these limitations, suppliers populate their website with low quality or tiny photos (thumbnails images) of their product and service offerings, thereby limiting file size and minimizing file download time. Also, at times, accessing a web page may be inconvenient or impossible.

Some limited marketing and product information is available on mass storage devices, such as magnetic disks and CD-ROMS, in the form of so-called electronic catalogs. Generally, the information in these catalogs is provided in the form of portable document format (PDF) files, which require Adobe Acrobat Reader to open and read. Some of these electronic catalogs are equipped with search capabilities to assist the buyer in finding the product or service required. To date, these electronic catalogs are simply electronic versions of the ubiquitous paper catalogs.

### SUMMARY OF THE INVENTION

The interactive marketing guide of the present invention is a rich media, interactive, cross-platform (i.e., compatible with a variety of computer operating systems) computer-controlled software package for guiding a consumer or buyer through a detailed process of identifying, evaluating, selecting and ordering a product or service. The directory format of the marketing guide offers multiple information types, including simple directory listings, general and detailed product/service information, detailed information about the listed vendors, and vendor advertisements. The multi-media and interactive content and web-style navigation provide substantially more product/service information than available with printed material, making the product selection process more focused and efficient (and more enjoyable too) than browsing through catalogs and brochures.

The interactive marketing guide includes a user-searchable active directory of product/service vendors. Upon locating a candidate supplier in the active directory listing, the supplier's relevant product advertisements are displayed. Alternatively, upon locating a potentially relevant advertisement, the user can access that supplier's directory listing. Using icons associated with the directory listing and/or the advertisements, the user can retrieve additional product/service information stored on the software guide. To retrieve yet additional information, (for example, more recent product/service data developed since the creation of the marketing guide) and to pose specific questions to the vendor, links are supplied to the vendor's website and e-mail address. In one embodiment, advertising space is sold by the guide developer, with the suppliers selecting the size and format of their advertisements, as well as the frequency with which they will be displayed and their placement on the screen. Thus the electronic nature of the guide allows for more variability in the display ads and the emphasis of one supplier over another, features which are unavailable in the prior art paper-based products. In one embodiment, when a supplier's directory information is displayed in one area of the screen, advertising information directed to that supplier or to all suppliers offering the product, is displayed in a second screen area.

The guide further includes a searching feature controlled by the user to locate specific suppliers or products. In the typical search process, the user searches by product category, by product or alphabetically by supplier. In response, the appropriate advertisements are displayed, e.g., all the ads related to the sought product from the several vendors offering that product. Clicking on the display ad takes the user to the supplier's interactive and static product information stored on the guide and to website information via an Internet link.

As product models and features change, these updates can be more easily effectuated in a portable electronic storage media than in a prior art paper product or catalog. Also, new products/services can be easily added and old ones deleted. The prior art paper-based products cannot duplicate the depth and breadth of information available on the portable electronic storage media and the ease with which the media can be searched for relevant information. The use of a portable mass storage device to provide such large volumes of available supplier and product information is a cost-effective alternative to expensive printing costs and mailings. Upon loading the data storage media into his or her computer, the potential buyer can execute all the steps required to purchase a product, including identifying the available products that will meet the need, analyzing the available products in depth, and ordering the selected product.

The guide content is targeted to the intended audience. One marketing guide relates to the relocation process, presenting the user with, for instance, real estate agents at the new location, neighborhood information, governmental agencies, tips on purchasing a new home, mortgage payment calculator, etc. For buyers of technical products, the marketing guide offers general and detailed product information in a searchable format to easily allow the buyer to locate, analyze and purchase the needed product.

### BRIEF DESCRIPTION OF THE DRAWINGS

The present invention can be more easily understood and the further advantages and uses thereof more readily apparent, when considered in view of the detailed description of the invention below and the following figures in which:

FIGS. 1 and 2 are display screen shots of various features of the interactive marketing guide according to the teachings of the present invention.

In accordance with common practice, the various described invention features are not drawn to scale, but are drawn to emphasize specific features relevant to the invention. Reference characters denote like elements throughout the figures and text.

### DETAILED DESCRIPTION OF THE INVENTION

Before describing in detail the particular interactive marketing guide in accordance with the teachings of the present invention, it should be observed that the present invention resides primarily in a novel combination of elements and process steps. Accordingly, these elements and steps have been represented conventionally in the drawings and referred to generally in the text, elucidating only those specific details that are pertinent to the present invention so as not to obscure the invention disclosure with details that will be readily apparent to those skilled in the art having the benefit of the description herein. Generally, the following description refers to a product analysis and selection process, although it is known that the came process can be applied to a service analysis and selection process.

According to the present invention, the interactive marketing guide comprises a portable storage medium operative by computer under user control to display a plurality of windowed areas and pages in which product and service information available from suppliers is provided to a potential buyer. Preferably, the portable storage medium is in the form of a CD-ROM, although the information can also be provided on other portable physical storage media based on optical or magnetic storage principles, including floppy disks and digital video disks (DVD's). The increased availability of solid state memories, such as the so called “memory sticks,” offer the opportunity to extend access to the marketing guide beyond the personal desktop or laptop computer to the more convenient handheld processing devices compatible with the memory sticks, such as a personal digital assistant (PDA) or e-book pad or reader. Storing the interactive guide on a memory stick or other portable storage medium conserves the limited storage capacity of the personal digital assistant, but retains user flexibility, as the user can access the guide whenever needed by inserting the appropriate memory stick into the PDA. Thus, the marketing guide information can be provided to the consumer on any portable storage media that is accessible by a microprocessor-based device.

Generally, the content of the guide allows a potential buyer to identify potential suppliers and peruse their product offerings by way of content provided in multiple formats from simple textual product descriptions to multimedia presentations, and additionally offering the buyer the capability to link to the supplier's web site or e-mail address to retrieve additional or more current information. As determined by the guide developer, the content of the stored information can be limited to a single product or service offered by competing suppliers in a submarket, home stereo speakers for example, or extended to include all products in the broader market of home stereo systems, including speakers, receivers, antennas, cabling, etc.

In a preferred embodiment the interactive marketing guide comprises an active directory providing supplier and product/service information in an interactive, searchable format. When provided in a CD-ROM package, the large storage capacity of the CD-ROM allows storage of several thousand pages of information in a compact, portable, user-friendly and searchable format. The advantages over the traditional printed directory of suppliers goods and services are readily apparent. Because the content is provided directly from the CD-ROM, an Internet connection is not required (although additional product information can be retrieved from the Internet and identified web sites), thus the information access time is much faster than a typical Internet download speed. In one embodiment, the active directory operates within a user's web browser window, i.e., Internet Explorer or Netscape Navigator. Upon insertion of the CD-ROM into the user's CD-ROM drive the active directory opens and the user is presented with the main search page. In one embodiment, the guide includes an autoplay feature that opens a CD-ROM browser menu. This menu allows the user to install the software (and a shortcut on the computer desktop that points guides search page on the CD-ROM), install the latest web browser from the CD-ROM, or jump directly to the guide's search page. From there, the user can search the directory alphabetically, by business category or by product keyword. The interactive guide is also equipped with an installation wizard that determines the software programs resident on the user's computer and then installs all necessary browsers, plug-in programs and viewers. These software programs can be included with the guide and downloaded into the computer as required or retrieved from a web-site.

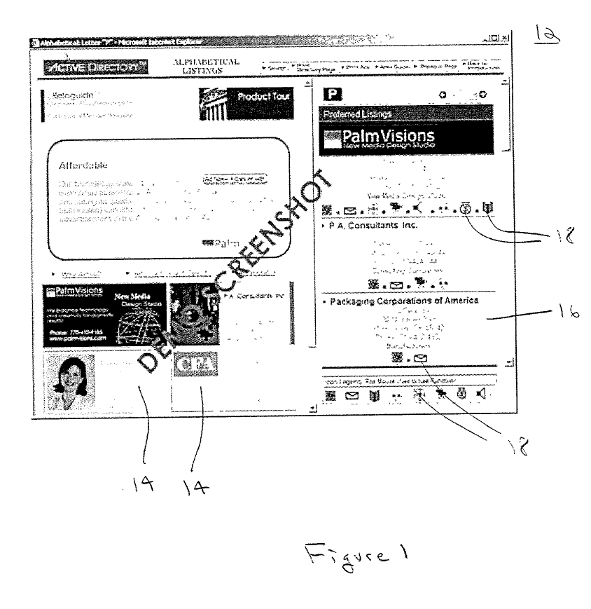

A screen shot of an active directory 12, as shown in FIG. 1, comprises display advertisements 14 and directory listings 16. The directory is characterized as “active” because it is interactive, allowing the user to easily find the desired product or service and supporting marketing material from the supplier, connects the user to enhanced information resident on the CD-ROM or to online content via the Internet, if an Internet connection is available. Typically, the buyer will first access text-based supplier overview and general product/service information on the CD-ROM. From the general information the buyer drills down to more specific information to gather additional product/service details. The more specific information can take the form of tables, charts, graphs, photographs, animated graphics and multimedia presentations (including audio and video messages) stored on the CD-ROM and accessed under user control.

In one embodiment, the display advertisements 14 are shown in the left-hand window of the active directory 12. The display ads 14 are context sensitive and time varying. That is, the content in the display ads changes to reflect the supplier or suppliers displayed in the directory listing 16 and/or the product/service sought by the buyer. Also, the individual ads can be programmed to change over time or in response to a given number of accesses by the user, while still remaining content sensitive. Thus the supplier can provide several content-sensitive ads to guide producer, all if which are stored on the CD-ROM, but their display is controlled by internal CD-ROM software. Also, the prominence of ads can be changed under control of the software as programmed by the producer. Suppliers can pay an advertising premium to have their ads displayed more frequently or more prominently, e.g., at the top or center of the advertisement window. As the user scrolls or searches through the suppliers in the directory listing 16, that supplier's ads appear in the left-hand window. In another embodiment, the suppliers advertisements appear in the left-hand window in response to a pointer or mouse click on the directory listing. Thus the suppliers can enhance their directory listing 16 with display ads, which can further include interactive options (audio, video, coupons, etc.). The directory listing 16, shown in the right-hand side window in FIG. 1, displays pertinent general information for each supplier, such as name, address and icon-based links 18 to more information. In one embodiment the icons 18 provide the user with a link to the supplier's display advertisement that appear in the left-hand window, a link to the supplier's web site, audio and/or vide messages, the supplier's e-mail address, and multimedia information such as video or audio clips, printable coupons, printable brochures, and a map and driving instructions to the supplier's place of business. Any of the information presented can be of a general nature about the supplier and the products it offers, or detailed information specific to one or more offered products/services. In one embodiment of the present invention, a buyers access to a suppliers website and e-mail address that is initiated through the interactive marketing guide is tracked by a software application operative in conjunction with the guide. This tracking feature, which is automatic, is designed to provide feedback to the advertisers concerning the web browsing activities of the potential buyers.

Although the guide can be browsed linearly like a book, typically a buyer's search process would proceed as follows. The user access the search page and searches for the product/service or company name. The search is executed alphabetically, by business, category, by business-to-business category or by a keyword/Boolean string search. The serach results are displayed with the retrieved directory listing displayed in the left-hand window and the advertisements displayed in the right-hand window. The display ads are context sensitive and hopefully will draw the users attention. Typically, the user will click on the most relevant display ad and in response that supplier's directory listing will appear at the top of the directory listing. From the directory listing the user can access all of the static, interactive and external (i.e., website) options and information available from the supplier. Alternatively, if the user first clicks on a directory listing, the supplier's display advertisement will appear at the top of the ad window area (the left-hand side of the display window).

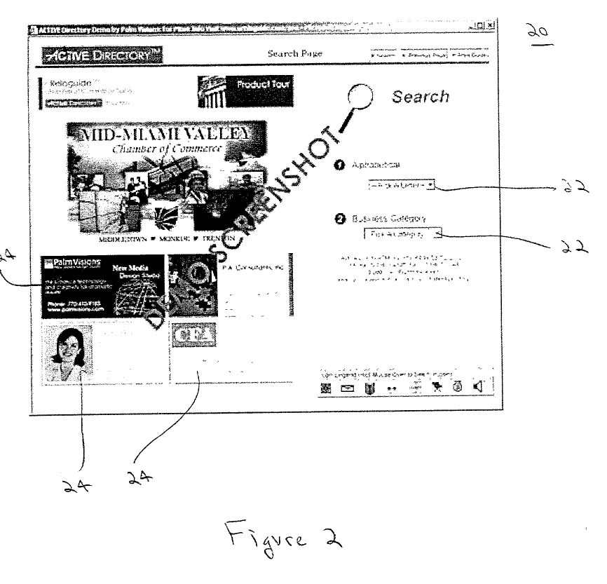

The search page is illustrated in FIG. 2, where search terms can be entered into fields 22 as discussed above. Advertisements 24 are also present on the search page 20. Generally, these advertisements are paid for by suppliers who wish to advertise in the marketing guide beyond those ads displayed in conjunction with their directory listing.

In one embodiment, the marketing guide includes non-product-specific generic content to assist the user by serving as a general information resource. For example, an attorney directory can include contact information for local courts, congressmen, etc. Also, the directory listings, advertisements and other information on the CD-ROM can be updated from a designated website by uploading the updates from the website and storing them in the computer hard drive for use in conjunction with use of the CD-ROM. Thus whenever the out-dated information is accessed on the CD-ROM, the updated information resident on the hard drive will be substituted for it.

The CD-ROM also includes live links to the businesses website for retrieving more detailed information than available on the CD-ROM and updates to information on the CD-ROM. Advantageously, by clicking on a specified icon or active link, the buyer is automatically linked to the supplier's web site without having to type in lengthy and awkward web site addresses. This also saves the buyer time by “deep-linking” directly to the website page of interest, instead of paging through the website home or main page to the desired page. A live link to the supplier's e-mail address opens an email window and populates the “TO” field with the supplier's email address. This provides a convenient mechanism for the buyer to pose specific questions or seek additional specific information directly from the supplier. Request-for-quote forms can also be included with the CD-ROM. The buyer fill in the requested information in the form, and the RFQ is automatically sent by e-mail to the supplier.

Whether the information is supplied directly from the CD-ROM or via a website, the information is available to the potential buyer twenty-four hours a day, seven days a week, with little or no extra effort required on the part of the supplier once the interactive marketing guide content has been developed and the CD-ROM produced, When the CD-ROM is prepared, each listed supplier selects the content (advertisements and product/service information) to be stored CD-ROM, directing the potential buyer to the supplier's website for additional information. Thus the supplier controls access to its website. In some cases, more access may be an important marketing tool. For instance, product coupons can be provided on the CD-ROM or on the website. In the later case, providing the supplier with potentially beneficial hits to its website and possibly resulting in the sell of additional products or services as a result of the visit, referred to as “up-selling” and “cross-selling.”

One application for an interactive marketing guide according to the teachings of the present invention is the homeowner relocation process. A relocation interactive marketing guide simplifies the difficult and strenuous moving process by offering the consumer direction and valuable information as the multi-step relocation process progresses, providing the homeowner with product/service information for every step of the relocation process from “thinking about the move” to “settling into your new home.” The guide offers valuable and informative content at each step of the process. This is beneficial from an advertiser's point of view in that repeated use of the guide by the consumer provides repeated exposure to the advertisers products/services. As discussed above, the multi-media content and flexible Internet style navigation make the guide both interesting and convenient to use. With the availability of both offline and online content, the consumer's use of the guide is optimized. Time sensitive information can be provided online through an Internet link provided by the guide, while time insensitive information is provided directly from the guide. The time insensitive (also referred to as static) content includes information such as local maps, general weather patterns, demographics, location of government offices, etc. The dynamic content available online includes, for example, a list of homes currently available in a specific locale, interest rates and credit reports. The use of a web browser to search, control and display the static information makes the transition to Internet-based content for the dynamic information seamless to the user. The search process is executed using HTML (hyper text mark-up language) or XML (extensible markup language). In one embodiment, the static information is customized based on the buyer's preferences. For instance, information presented can be limited to only specific locales within the destination geographic area or to homes larger than a minimum number of square feet. Once the buyer identifies the area in which he or she is interested in purchasing a home, the marketing guide with specific content for only that area is consulted. Due to the relatively low cost of creating a marketing guide on a CD-ROM, the guides can be provided at no cost to a potential home buyer by a real estate agent or a chamber of commerce representing the area into which the buyer is moving.

Multi-media content on the marketing guide enhances the presentation of material to the buyer. For example, the guide can include photos or video clips of homes for sale (although this may not be ideal because homes come onto the market and leave the market daily) and audio clips from residents living in the area or local politicians extolling the virtues of the area. Typically, time sensitive multi-media information can be more advantageously supplied via a website. But the CD-ROM format offers access speeds in excess of 100 times faster than typical Internet download speeds. Use of the portable storage format also allows access by a user who does not have an Internet connection or a user traveling with a laptop where no Internet connection is available.

In one embodiment, certain home-buying tools or algorithms are also provided in the marketing guide. For instance, an algorithm for calculating the monthly principal and interest payments for a given home price and down payment can be included. Other useful tools include a personal property inventory guide and a relocation expense tracker. Although certain of these tools may be available on the Internet, a CD-ROM format offers the user faster access and a degree of privacy not available from an Internet-based version. Some consumers may be reluctant to provide such detailed, personal information over an Internet connection. Instead, according to the teachings of the present invention, this information is stored directly on the user's personal computer. The relocation guide can be distributed by real estate agents or local chambers of commerce to those expressing an interest in relocating to the area. Once the content has been prepared, the production of additional CD-ROM's is relatively inexpensive. Also, a positive message is communicated by giving a gift, such as the CD-ROM, to a potential buyer. The alternative of simply directing the buyer to an Internet website by providing a website address is less attractive.

In yet another embodiment, the buyer is encouraged to register the marketing guide software package via a link to an identified website. Registration allows the CD-ROM provider to offer related information and advertisements, for example by targeted mailings and email information. External website links accessed from the marketing guide pass “through” the registration site, allowing website use statistics to be captured. This information can then be analyzed to offer targeted advertising and sales offers to the user.

In one embodiment, the marketing guide is provided to a potential buyer by a “sponsor”. Typically, the sponsor will be a real estate agent, mortgage company, builder, developer, chamber of commerce, etc. When the marketing guide is opened, an advertisement for the sponsor is displayed in the form of a splash page or a short multi-media presentation. Thereafter, the sponsor's information is integrated with every other page or content of the guide. For example, information and advertisements for the sponsoring mortgage company will be displayed on the guide as the user navigates through the various information sources. The continuous and frequent exposure to this information serves as an important marketing tool for the sponsor.

Beyond the marketing and advertising information presented, the marketing guide can serve as a valuable information resource for the buyer by the inclusion of general content information. One additional layer of content includes school and church information, local civic and recreational activities, local census data, etc. Another content layer can provide a unique selling proposition for a specific real estate agent, such as their experience, testimonials, credentials, a marketing plan, etc. Yet another content layer can include a directory of local businesses, especially businesses with which the new homeowner needs to immediately establish a relationship, such as banks, with several banks advertising their services. The user can select or browse through the advertising banks for additional information offered by way of text, multi-media presentations stored within the marketing guide and a link to the bank's website for the retrieval of even more information. Advantageously from the sponsor's or advertiser's prospective, the user will typically use the marketing guide repeatedly, providing repeated exposures to the advertisers message.

Another exemplary interactive marketing guide provides information about local health clubs. The potential member receives the marketing guide, typically in the form of a CD-ROM, from a sponsoring organization such as an employer, labor union or medical practitioner. The marketing guide directory (reference character 18 of FIG. 1) includes a list and contact information for local health clubs. Display advertisements of one or more of these health clubs are provided as indicated by the display ads 24 of FIG. 2. The remaining CD-ROM content associated with each listed health club is provided at the option of the health club. For instance, certain clubs may wish to include a list of the available work-out equipment. A virtual club tour (in the form of digital video clips) can also be provided so that the potential member can “tour” each club without physically visiting the club. Membership information and a sample agreement can be included, as well as a link to the club e-mail address, allowing the user to submit a completed membership application. Finally, generic fitness, diet and health information can be made available on the CD-ROM. Use of this information could be interactive in nature. For instance, the user enters his age, actual weight, and desired weight. Using this information, the calculator determines the nature of the exercises that will allow the user to reach the desired weight.

The teachings of the present invention can also be applied to the business-to-business marketing and product selection process. For example, during the design process of a new cellular telephone handset, the manufacturer must purchase an appropriate antenna from a supplier. Rather than employing the prior art processes of calling suppliers to request technical information, or consulting catalogs published by individual suppliers or distributors representing several suppliers, the designer consults a CD-ROM (or other portable storage media device) developed according to the teachings of the present invention and containing antenna product information. The guide can be supplied by individual antenna suppliers, in which case only the supplier's products will be described, or by an organization representing several antenna suppliers (a distributor, for example) or an umbrella organization in which electronics product suppliers are members (the Electronics Industry Association, for example). The antenna descriptions within the guide can include: simple textual descriptions setting forth the antenna operational and physical parameters (input resistance, gain, directivity, length, etc.), graphs of the beam patterns, and photographs of the antenna. The CD-ROM can also include interactive features, for instance, permitting the user to input an operational frequency value for a specific antenna and observe the change in beam patterns as the frequency is varied. The CD-ROM may also include generic antenna reference data and algorithms for calculating antenna parameters across a class of antennas, independent of the antenna supplier. An algorithm in the latter category could, for example, calculate the antenna gain based on the antenna parameters supplied in the textural information. In this way, the designer can calculate and then compare several antenna gain values to aid in the selection of the best antenna for the application.

While the invention has been described with reference to preferred embodiments, it will be understood by those skilled in the art that various changes may be made and equivalent elements may be substituted for the elements thereof without departing from the scope of the invention. The scope of the present invention further includes any combination of the elements from the various embodiments set forth herein. In addition, modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all other constructions falling within the scope of the appended claims.

What is claimed is:

1. An apparatus for providing pertinent product/service information to a buyer, comprising:
a portable storage medium;
a processor for controlling said portable storage medium;
said portable storage medium for storing at least the following product/service information types, wherein each one of said product/service information types has a plurality of entries:
a directory including one or more businesses offering the product/service;
descriptive information of the products/services offered by the one or more businesses;
advertisements of the products/services offered by the one or more businesses;
links to external information not available on said portable storage medium, wherein said external information is related to the products/services offered by the one or more businesses;
a search engine for searching the plurality of entries of one or more of the information types, through buyer-provided commands to said processor for identifying the pertinent entries; and
a display for displaying said pertinent entries through user-provided commands to said processor.

2. The apparatus of claim 1 wherein the storage device further stores an information type comprising generic product/service information.

3. The apparatus of claim 1 wherein the external information is available at a website.

4. The apparatus of claim 1 wherein the portable storage medium is selected from among a CD-ROM, a DVD and a memory stick.

5. The apparatus of claim 1 wherein the user provided commands to the search engine include commands for searching the directory to identify entries from among the plurality of entries comprising business offering a product/service desired by the buyer.

6. The apparatus of claim 1 wherein the user provided commands to the search engine include commands for searching the directory alphabetically.

7. The apparatus of claim 1 wherein the user provided commands to the search engine include commands for searching the directory to identify entries from among the plurality of entries comprising business offering a product/service within a category of products/services desired by the buyer.

8. The apparatus of claim 1 wherein the user provided commands to the search engine include commands for searching the descriptive information for a product/service desired by the buyer.

9. The apparatus of claim 1 wherein the display displays product/service advertisements related to the pertinent entries.

10. The apparatus of claim 9 wherein the pertinent entries include at least one entry from the directory, and wherein the displayed product/service advertisements are related to the at least one entry from the directory.

11. The apparatus of claim 9 wherein the product/service advertisements change over time.

12. The apparatus of claim 9 wherein selected ones of the product/service advertisements are displayed with a greater prominence than others of the product/service advertisements.

13. The apparatus of claim 12 wherein the product/service advertisements displayed with a greater prominence change over time.

14. The apparatus of claim 1 wherein the product/service information is related to the targeted needs of the buyer.

15. The apparatus of claim 1 wherein the product/service information is related to the homeowner relocation process.

16. The apparatus of claim 1 wherein directory entries related to the pertinent product/service information are displayed in a first region of the display and product/service advertisement entries related to the pertinent product/service information are displayed in second region of the display.

17. The apparatus of claim 1 wherein one or more of the product/service advertisement entries include buyer-selectable links to other information types entries related to the product/service advertisement entry.

18. The apparatus of claim 17 wherein the other information types are selected from among directory entries, descriptive information entries, external information entries and generic information entries.

19. The apparatus of claim 1 wherein one or more of the directory entries include buyer-selectable links to other information type entries related to the directory entry.

20. The apparatus of claim 19 wherein the other information types are selected from among directory entries, descriptive information entries, external information entries and generic information entries.

21. The apparatus of claim 1 wherein the descriptive information entries comprise interactive entries, photograph entries, video entries, audio entries, multimedia entries, textual entries, graphical entries, printable entries, email address entries and website address entries.

22. The apparatus of claim 1 further comprising a website storing updated contents for the portable storage medium, wherein under buyer control, the processor is directed to the website for downloading the updated contents for use in conjunction with the portable storage medium.

23. The apparatus of claim 1 further comprising a website for tracking the links to the external information selected by the buyer.

24. An information management system for providing information to a user related to one or more products/services, said information management system comprising:
a computer processor under user control for processing and presenting information;
a storage media for storing static product/service information;
a communications device for accessing additional product/service information external to said storage media;
an input device for providing user-selected commands to said processor for manipulating the static and the additional information; and
a display device for displaying the static and the additional information in response to user-issued commands to said processor.
